(19) United States
(12) Patent Application Publication
(10) Pub. No.: US 2025/0168558 A1
(43) Pub. Date: May 22, 2025

(54) Clip Assembly for Electronic Device

(71) Applicant: Stryker Corporation, Portage, MI (US)

(72) Inventors: Prakash Guda, Portage, MI (US); Peng Jiang, Portage, MI (US); Yilun Zhang, Portage, MI (US)

(21) Appl. No.: 18/841,230

(22) PCT Filed: Jan. 12, 2023
(86) PCT No.: PCT/US2023/060514

§ 371 Date: Aug. 23, 2024

Related U.S. Application Data
(60) Provisional application No. 63/268,699, filed on Feb. 28, 2022.
(60) Provisional application No. 63/269,221, filed on Mar. 11, 2022.

(51) Int. Cl. H04R 1/40; A45F 5/02; H04R 1/02

(52) U.S. Cl. CPC H04R 1/406; A45F 5/02; H04R 1/028; A45F 2005/025; H04R 2201/023; H04R 2201/403

(57) ABSTRACT

An example assembly (500) includes a user device (302) and a clip assembly (306, 502). The user device has a snap insert (504) having an annular groove (510) bounded by a first annular surface (512) and a second annular surface (514); and a clip assembly. The clip assembly includes a base jaw (520), a pivotable jaw (522) pivotably-coupled to the base jaw, a strap (542) pivotably-coupled to the base jaw at a first end of the strap, and a snap button (506) pivotably-coupled to the strap at a second end of the strap, wherein the snap button comprises a hole (516) and a flexible ring (518) mounted therein, such that as the snap insert of the user device is inserted into the snap button through the hole, the flexible ring is positioned within the annular groove and retained between the first annular surface and the second annular surface, such that the user device is pivotably-coupled to the second end of the strap.

### REFERENCE TO RELATED APPLICATIONS

This application claims priority to U.S. Provisional Patent Application No. 63/268,699, filed Feb. 28, 2022, and to U.S. Provisional Patent Application No. 63/269,221, filed Mar. 11, 2022, the entirety of each which is hereby incorporated by reference.

### BACKGROUND

Providing patient care in healthcare facilities (e.g., hospitals) generally necessitates interaction between healthcare workers (e.g., doctors, nurses, pharmacists, technicians, nurse practitioners, etc.) and between those healthcare workers and various devices/systems that support treatment of patients.

Many healthcare facilities have already installed one or more wireless networks to support wireless communication devices such as laptop computers and mobile phones that could facilitate this interaction. These wireless networks typically use standard wireless networking protocols, such as one of the 802.11 standards, with wireless access points distributed throughout the facilities and coupled with each other and/or with other network nodes using wireless mesh networking and/or wired (e.g., Ethernet) networking. When in coverage of such a network, healthcare workers may thus use their wireless communication devices in a conventional manner, to engage in calls with each other and perhaps to communicate with a centralized healthcare management system, among other possibilities.

### SUMMARY

One challenge that healthcare workers could face when using conventional wireless communication devices to communicate with each other and with supporting systems in typical healthcare facilities is that it may be inconvenient or impractical for the healthcare workers to hold and operate those devices as they go about their business. Even though some devices may support hands-free communication, a user may still need to hold and physically interact with the device to engage in certain functions such as powering on the device, dialing calls, or the like. For instance, a user may need to hold the device while interacting with a graphical user interface on a screen of the device and/or with a physical keypad or other such interface of the device.

As presently contemplated, a solution to this problem is to equip healthcare workers with specialized communication devices that rely largely on voice interaction. Such a device could be small, portable, and lightweight, configured to be worn by a healthcare worker (e.g., clipped to a shirt collar or worn on a neck-strap), and could operate in an always-on state, enabling the healthcare worker to quickly and conveniently place and receive calls, receive alerts, and interact with supporting systems, all without a need to hold the device and with minimal or no need to even touch the device.

Representative healthcare facilities could be configured with a communication system and associated systems that support use of such devices, and each healthcare worker could wear and use one of the devices. In particular, the communication system could include a wireless network having one or more wireless access points that the devices could communicate with using a standard or proprietary wireless communication protocol. And the communication system could include a central computing system that the devices could communicate with through the network and that controls and/or facilitates various communication operations. The healthcare workers could then conveniently make use of their devices to place and receive calls with each other and to engage in communication with the central computing system, to facilitate accessing healthcare information, receiving or sending messages, indications, or alerts, and engaging in other communications.

A representative communication device, also referred to as a “user device” or electronic device, could be powered by a rechargeable battery and could include one or more microphones for receiving voice or other audio input and one or more speakers and/or other interfaces for outputting voice or other audio. Further, the device could include one or more LEDs, haptic actuators, and/or other mechanisms for presenting visual, haptic, or other indications or alerts to the user. And the device could include a WiFi communication module or other wireless communication module to enable the device to communicate with the central computing system.

When such a device powers on within the healthcare system or otherwise enters into the healthcare system, the device may use its WiFi module to scan for WiFi coverage and may acquire WiFi connectivity with a nearby access point, and the device may then engage in signaling through the network with the central computing system, to register its presence and active state in the system. Once the device is so connected and registered, the device may then engage in communications with and through the central computing system, to facilitate communicating with other users and with associated systems.

In an example implementation, the device could be configured to receive voice commands from its user and to convey those voice commands to the central computing system for processing. For example, to initiate a voice call to another user, the user may speak call-initiation voice command designating a name of the other user, the device may responsively convey that voice command to the central computing system, and the central computing system may then engage in signaling to set up the requested voice call to the other user and may bridge the call, enabling the users to talk with each other. As another example, to request assistance or action to serve a patient, the user may speak an associated voice command expressing the request, the device may responsively convey that voice command to the central computing system, and the central computing system may process the request for assistance, perhaps conveying the request to one or more associated users and/or departments for handling.

The orientation of the user device may affect the ability of the microphones of the user device to receive user voice commands. For example, it may be desirable to have the user device hanging vertically so that the microphone can correctly receive voice commands from the wearer. Also, in such orientation, the wearer could see indicator lights on the top of the user device. In an example implementation, the user device is pivotably coupled to a clip assembly that can be clipped to clothes of the wearer and facilitate hanging the user device vertically. In this example, the clip assembly may include a strap to which a clip is pivotably-coupled at a first end of the strap such that the strap can rotate freely relative to the clip. Further, the user device is pivotably-coupled to a second end of the strap such that the user device can rotate freely relative to the strap. With this configuration, the center of gravity of the user device keeps it hanging vertically so that its microphone can correctly receive voice commands from the wearer, and the wearer could also see the indicator lights on the top of the device.

As mentioned above, the user device is powered by a rechargeable battery. It may be desirable to facilitate positioning the battery within the user device in one correct orientation, and also facilitate positioning the battery in a charging bay in one correct orientation. In other words, the battery cannot be positioned in the user device or the charging bay in a wrong orientation that does not power the device or charge the battery. In an example implementation, the battery has a structure that ensures both (i) that the battery fits into a battery receptacle of the user device in only one intended orientation, and (ii) that the battery fits into a charging-bay battery receptacle in only one intended orientation. For instance, the battery can have a chamfered corner and an alignment tab. The battery receptacle in the user device can have a corresponding chamfered corner and a slot configured to receive the alignment tab. This way, the battery can be placed into the battery receptacle of the user device in only one orientation. In any other orientation, either the alignment tab, the chamfered corner, or both will not align with the corresponding features of the battery receptacle, and thus the battery cannot be inserted into the user device.

It is further contemplated herein that the battery has an angled side surface such that the battery is configured as a trapezoidal prism. The charging bay can have a corresponding angled side surface. With this configuration, the battery can be positioned within the charging bay in only one correct orientation.

These as well as other aspects, advantages, and alternatives will become apparent to those of ordinary skill in the art by reading the following detailed description, with reference, where appropriate, to the accompanying drawings. In the drawings, similar symbols typically identify similar components, unless context dictates otherwise.

### BRIEF DESCRIPTION OF THE FIGURES

FIG. 1 is a simplified illustration of an example communication system in which an example user device may operate.

FIG. 2 is a simplified block diagram depicting example application programs in a central computing system operable in the system of FIG. 1.

FIG. 3A illustrates a left/front side perspective view of an example user device.

FIG. 3B illustrates a right/back side perspective view of the example user device.

FIG. 3C illustrates a right side view of the example user device.

FIG. 3D illustrates a left side view of the example user device.

FIG. 3E illustrates a top side view of the example user device.

FIG. 3F illustrates a bottom side view of the example user device.

FIG. 3G illustrates an exploded view of the example user device.

FIG. 3H illustrates a view of the example user device worn by an example user.

FIG. 4 is a simplified block diagram showing hardware components of the example user device.

FIG. 5A illustrates an exploded perspective view of an assembly including a user device and a clip assembly, in accordance with an example implementation.

FIG. 5B illustrates a partial cross-sectional side view of the assembly of FIG. 5A, in accordance with an example implementation.

FIG. 5C illustrates a perspective view of a snap insert, in accordance with an example implementation.

FIG. 5D illustrates a side view of the snap insert of FIG. 5C, in accordance with an example implementation.

FIG. 5E illustrates a cross-sectional view of a snap button, in accordance with an example implementation.

FIG. 5F illustrates a side view of the clip assembly of FIG. 5A, in accordance with an example implementation.

FIG. 5G illustrates an exploded perspective view of the clip assembly of FIG. 5F, in accordance with an example implementation.

FIG. 6A illustrates a perspective view of a battery, in accordance with an example implementation.

FIG. 6B illustrates a front view of the battery of FIG. 6A, in accordance with an example implementation.

FIG. 6C illustrates a side view of the battery of FIG. 6A, in accordance with an example implementation.

FIG. 6D illustrates a top view of the battery of FIG. 6A, in accordance with an example implementation.

FIG. 6E illustrates a bottom view of the battery of FIG. 6A, in accordance with an example implementation.

FIG. 6F illustrates a cross-sectional side view of the user device of FIG. 5A with the battery of FIG. 6A disposed therein, in accordance with an example implementation.

FIG. 6G illustrates a perspective view of a charging bay and the battery of FIG. 6A being placed therein for recharging, in accordance with an example implementation.

FIG. 7 is a flowchart of a method for coupling a battery to a user device, in accordance with an example implementation.

### DETAILED DESCRIPTION

Example systems, methods and apparatus are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems, methods, and apparatus can be arranged and combined in a wide variety of different configurations, all of which are contemplated herein. In addition, the particular arrangements shown in the figures should not be viewed as limiting. It should be understood that other embodiments might include more or less of each element shown in a particular figure. Additionally, some of the illustrated elements may be combined or omitted. Yet further, an example embodiment may include elements that are not illustrated in the figures.

Example embodiments described herein relate to systems, methods, and apparatus for enabling communications in a communication system. The communication system could comprise a user device for each user, one or more access points with which each user device may communicate, and a central computing system that may control and facilitate communication within the communication system. The central computing system and the access points may be connected together by a computer/communications network, such as a local area network (LAN), a wide area network (WAN), or another other similar network.

As noted above, the user device could be a portable wireless device that supports hands-free, voice communications. The user device could include one or more microphones that receive voice commands and other voice input from a user, and one or more speakers that generate audible output signals. Further, the user device could include a wireless communication module, enabling the device to connect with the network and engage in communication through the system.

The user device could be sufficiently small and lightweight enough so that the user could comfortably wear the device by clipping the device onto the user's collar or shirt pocket or wearing the device on a lanyard around the user's neck. In an example implementation, hands-free operation of the device using voice commands uttered by the user may also require the device to be situated within no more than a particular distance below the chin of the user so that the device can receive the voice audio from the user with sufficient volume and at an expected angle of arrival, to facilitate recognition and processing of the voice by the device and/or the central computing system.

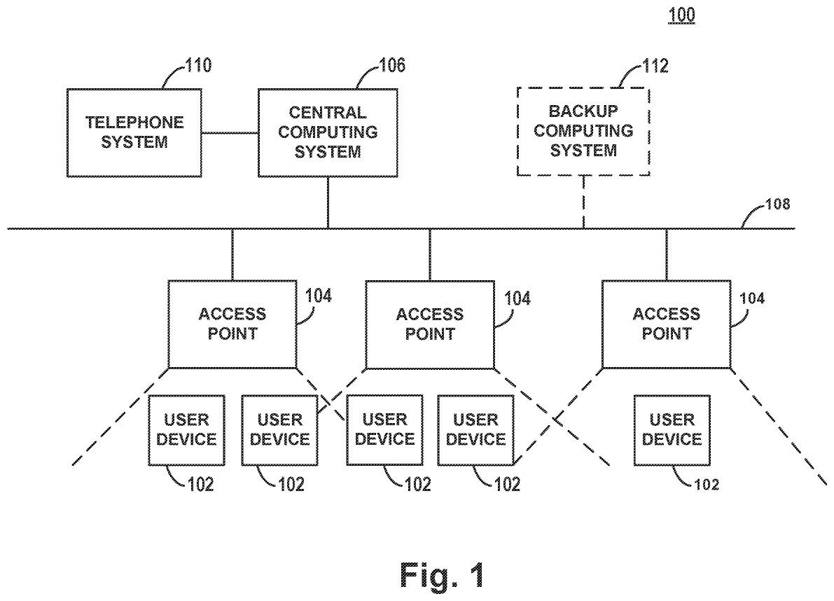

FIG. 1 is a simplified illustration of example communication system 100 that could enable communication between users each equipped with the representative user device, and between those users and supporting systems. As illustrated, the example communication system includes multiple user devices 102, multiple wireless access points 104, and a central computing system 106, such as a server computer or cluster of computers. Further, as shown, the central computing system 106 and access points 104 could be connected with each other over a communication network 108, such as a LAN and/or WAN, to facilitate communication between the user devices 102 and the computing system 106. In addition, as shown, the computing system may be connected to a telephone system 110, such as the private branch exchange (PBX) system and voicemail system, to facilitate connecting outside calls. And the communication system 100 could further include a backup computing system 112 (shown in phantom), also with the computer network 108.

In an example implementation, the access points 104 could be located in a workplace or other facility (e.g., building), such as within healthcare facilities for instance, or could be distributed among multiple such facilities. For instance, for a large work environment encompassing multiple facilities, network 108 might comprise multiple LANs interconnected through the Internet or other WAN, with access points 104 distributed throughout each LAN. In that implementation, the central computing system 106 could also be distributed throughout the various facilities, and/or a central system could control communications within and between all of the facilities. Other arrangements could be possible as well.

The access points 104 of the wireless commination system 100 may be wireless access points that use standard wireless protocols, likely IEEE 802.11 standards supporting WiFi communication, but also possibly other protocols such as BLUETOOTH, ZIGBEE, or the like. In other embodiments, the access points could comprise cellular base stations operating according to a cellular wireless protocol, such as Long Term Evolution (LTE) or 5G New Radio (5G NR), among other possibilities. In any case, the wireless communication module of each user device 102 could be configured to support corresponding communication. For instance, if the access points 104 support WiFi communication according to 802.11 standards, each user device's wireless communication module could correspondingly support WiFi communication and service by the access points 104.

Each access point 104 could provide a respective coverage area within which to serve user devices 102. The range of this coverage area could depend on various factors, such as antenna configuration, power settings, and wireless communication protocol for instance. Further, to permit handoff of user devices between the access points 104, the access points 104 could be positioned and configured so that their coverage areas overlap with each other as shown in the figure. When a user device initially powers on or otherwise enters into coverage of this system, the user device may scan for coverage of an access point. And upon detecting coverage of an access point with sufficient signal strength, the user device may then engage in signaling to connect with the access point. Once connected with the access point, the user device may then engage in communication through the network 108 with the central computing system 106 and ultimately with other user devices and/or with supporting systems.

In an example implementation, the central computing system 106 could be responsible for the overall control and operation of the communication system 100. To facilitate this, the central computing system 106 could include a network communication interface (e.g., Ethernet interface) for communicating on network 108, and could further include one or more processing units (e.g., one or more general purpose processors such as microprocessors, and/or one or more specialized processors such as digital signal processors or application specific integrated circuits), non-transitory data storage (e.g., one or more volatile and/or non-volatile storage components such as read-only memory (ROM), random access memory (RAM), electrically erasable programmable read only memory (EEPROM), flash memory, optical storage, magnetic storage, or the like), and program instructions stored in the data storage and executable by the processing unit(s) to carry out various computing system operations. Without limitation, for instance, the computing system 106 could be programmed with software application programs running on an operating system such as a Windows or Linux based operating system.

Among other operations, the central computing system 106 could maintain records of profile and presence state of the user devices 102 that are configured to operate in the communication system 100. For instance, the computing system 106 could maintain profile records that assign particular users to particular user devices 102 and that include other associated information such as user name, job title, department, and contact lists, as well as voice signatures or the like. Further, the computing system 106 could maintain presence or registration records, indicating for each device whether and when the device is present and connected within the communication system and perhaps which access point is currently serving the device.

Once a user device 102 connects with an access point in the communication system 100, the user device 102 may then engage in registration signaling with the computing system 106 to register its presence in the communication system 100, and the computing system 106 may update a presence record for the user and the user device 102 accordingly. Further, while so connected, the user device 102 may also send periodic heartbeat messages to the computing system 106 to inform the computing system 106 that the user device 102 remains actively connected. And when the computing system 106 stops receiving those heartbeat messages from a user device 102 or otherwise learns that the user device 102 is no longer actively connected in the communication system 100, the computing system 106 may update the user's and device's presence record to indicate that the user device 102 is no longer actively connected.

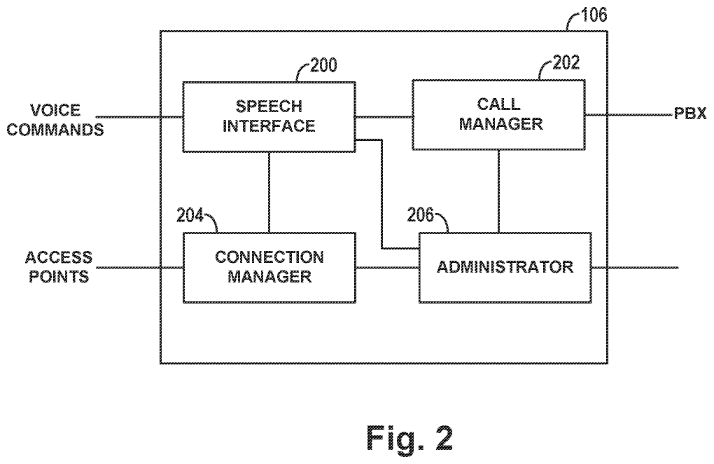

FIG. 2 is a simplified block diagram depicting example application programs that could be included in the computing system 106. As shown in FIG. 2, the example application programs include a speech interface 200, a call manager 202, a connection manager 204, and an administrator 206. In an example implementation, the speech interface 200 could include a conventional software-based engine that supports text-to-speech and speech-to-text conversion, enabling the computing system to receive, interpret, and execute voice commands from the user devices 102 and to provide voice-based messaging to the user devices 102 for presentation. The call manager 202 could include a conference bridge system that supports setting up and connecting calls between the user devices 102 and perhaps with an external telephone network, and may support two-party and multi-party calls. The connection manager 204 may function to maintain presence and registration information regarding user devices 102 as noted above. And the administrator 206 may provide a web-based interface to facilitate configuring and monitoring of the communication system 100. Other arrangements could be possible as well.

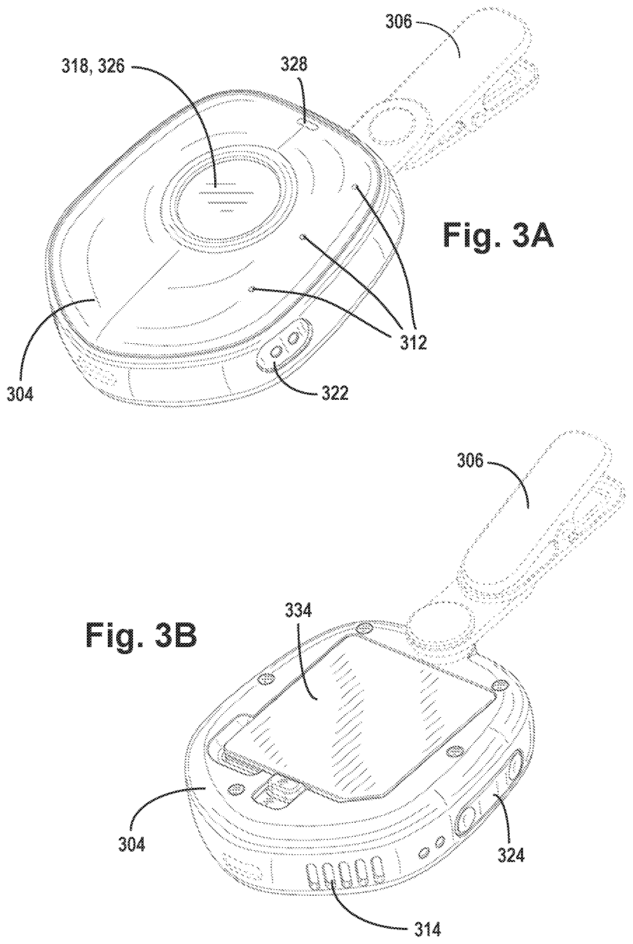

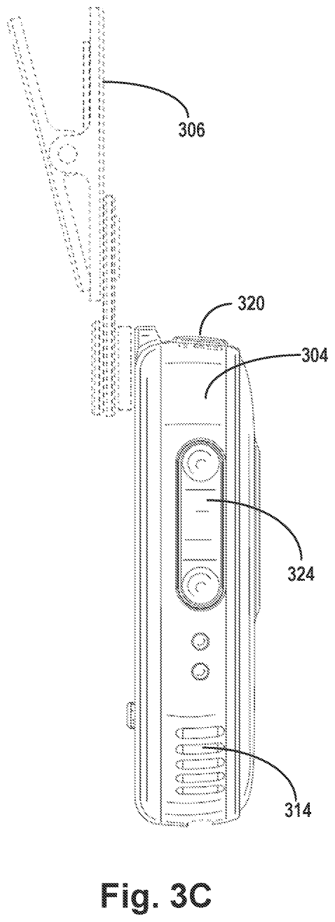

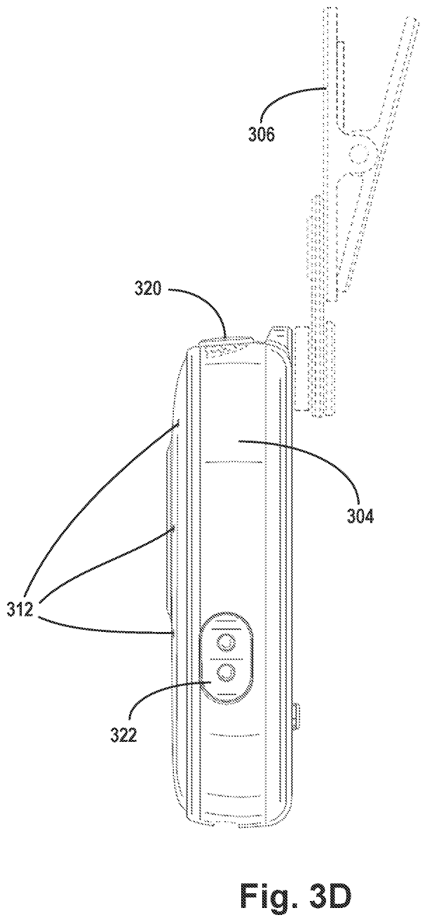

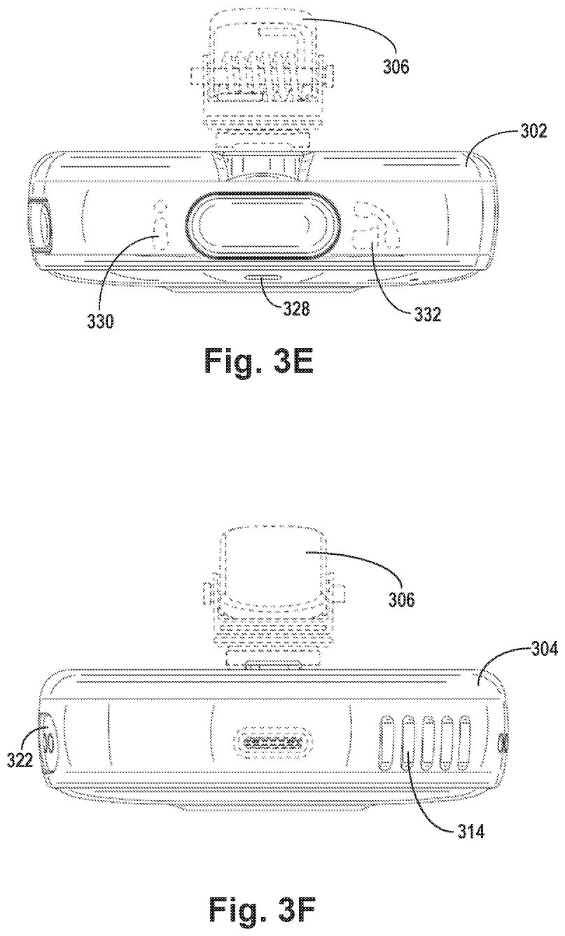

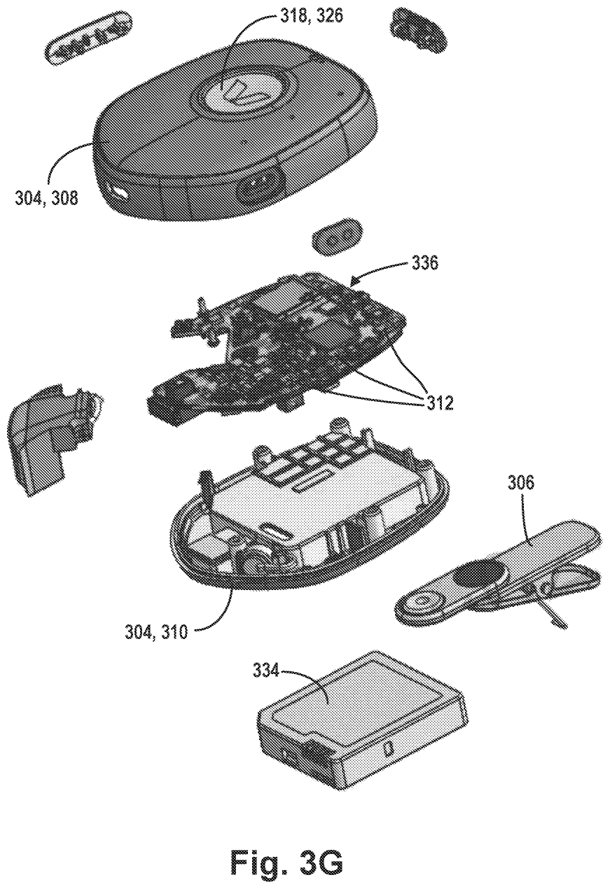

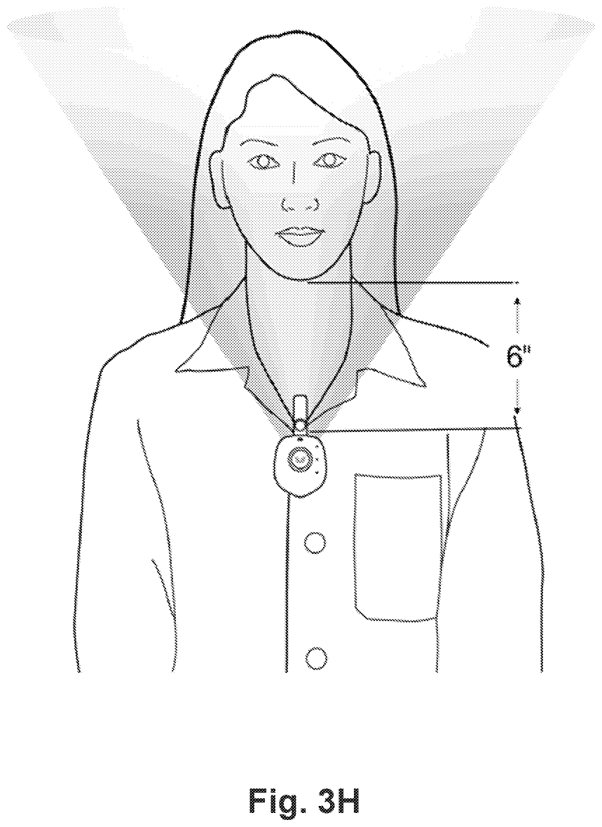

As noted above, the user device 102 could be a lightweight, portable, battery powered device, configured to support voice-based communication and wireless network communication. Such a device could take various forms. Without limitation, FIGS. 3A-3G depict a representative example device as user device 302.

As shown in FIGS. 3A-3G, the example user device 302 includes a device housing 304, with an associated clip assembly 306 that enables clipping of the device onto a user's collar, shirt pocket, or the like, or onto a lanyard worn around the user's neck.

As shown in the exploded view of FIG. 3G, the device housing 304 of the device 302 could be formed from multiple pieces that are joined together. For example, the device housing 304 could have a front cover 308 and a back cover 310. In other embodiments, the device housing 304 may be formed as a single piece construction. The device housing 304 could be constructed using a variety of manufacturing processes, such as, for example, injection molding and/or vacuum forming. In addition, the device housing 304 could be formed from a number of materials, including, but not limited to, thermoplastic polyurethane (TPU), plastic, metal, rubber, and/or a combination of these and/or other materials.

As shown in FIGS. 3A, 3D, and 3G, the device 302 includes a linear microphone array 312, which is shown accessible through holes in a front surface of the device housing 304 but could alternatively be arranged to be accessible through holes at a side surface or elsewhere on the device housing 304. The linear microphone array 312 could include three linearly aligned microphones as shown, or could alternatively include a different number of linearly aligned microphones, optimally at least two microphones that are vertically spaced from each other by a distance on the order of 2 to 5 centimeters or so. (In an alternative implementation, the microphones could be horizontally offset from each other rather than being directly in line with each other, but would still be vertically spaced from each other.) The microphones of the linear microphone array 312 could be digital microphones configured to receive acoustic input and to convert the acoustic input into a stream of digital samples for processing by the device 302.

In addition, as shown in FIGS. 3B, 3C, and 3F, the device 302 includes a speaker 314, which is shown accessible through holes at a bottom side surface of the device housing 304 but could alternatively be disposed elsewhere on the device housing 304, optimally far enough away from the linear microphone array 312 to help prevent feedback or other issues. The speaker 314 is configured to output voice, tones, and/or other audio to be heard by the user.

As additionally shown in FIGS. 3A-3G, the device 302 includes a number of user-accessible buttons, such as an activation button 318, a do-not-disturb/hold button 320, a panic button 322, and volume-control buttons 324.

The activation button 318 may be a primary control for user interaction with the device 302, as an alternative or in addition to voice control of the device 302. Further, the activation button 318 could invoke various different device functions depending on context. For instance, depending on context, the user may engage the activation button 318 to initiate a dialog with a system agent (the “Genie”) or may engage the activation button 318 to accept an incoming call or to initiate other call-related functions. In addition, the device 302 may respond differently to engaging on the activation button depending on whether the user presses and immediately releases the button or the user presses, momentarily holds, and then releases the button.

The do-not-disturb/hold button 320 may also be a momentary push button, or may be a toggle switch, specifically for placing the user device 302 in a do-not-disturb (DND) mode if no call is currently in progress or in a hold mode if a call is in progress. As shown, the DND/hold button 320 could be disposed at the top of the device 302, for convenient access. Further, the DND/hold button 320 may be backlit by a multi-color LED that is normally inactive but that turns on when the device 302 is in the DND mode or hold mode, possibly lighting differently depending on which of these modes is on-such as blinking while the device 302 is in the DND mode or being continuously illuminated while the device 302 is in the hold mode.

The panic button 322 may likewise be a momentary push button, situated near or at the top of the device 302 for convenient access. When the user engages the panic button 322, the device 302 may send a panic message, which may cause the central computing system 106 to send notifications to other users, indicating an emergency or urgent matter. Further, the volume-control buttons 324 may have a push-button configuration and be situated along a side of device 302 as shown, enabling the user to change volume of audio output (e.g., speaker) of the user device 302.

In addition to the LED indicators of the DND/hold button, the device 302 may include a number of other surface-facing LED indicators, some of which are shown in FIGS. 3A, 3E, and 3G. These indicators include a status indicator 326, a connectivity indicator 328, an alert indicator 330, and a message indicator 332. Further, the device may also include an internal haptic device configured to produce haptic vibration to indicate various alerts, status, or other information.

The status indicator 326 is integrated with the activation button 318 and could output various different colors to indicate various different operations states of the device 302. For instance, the status indicator 326 may slowly blink a green light to indicate that the device 302 is within wireless coverage of the communication system 100, the status indicator may slowly blink a red light to indicate that the device 302 is not within coverage of the communication system 100. Further, other blinking patterns and light colors could be used to indicate other conditions, such as that battery level of the device is threshold low for instance. The status indicator 326 and activation button 318 may also cooperatively display a logo, design, or other pattern, such as a company logo, as shown in FIG. 3G for instance.

The connectivity indicator 328 could indicate whether the device 302 is connected with the communication system 100, such as whether the device has established WiFi connectivity with an access point 104 for instance. Like the status indicator 326, the connectivity indicator 328 may present various different colors and/or blinking patterns to indicate various different states. For instance, the connectivity indicator 328 could present a solid green light to indicate when the user device is connected with the communication system 100 and could present a white or yellow light to indicate when the user device is not connected with the communication system 100.

The alert indicator 330 could function to present an alert to the user of the device 302 and may present different colors to indicate various different alerts. Further, the message indicator 332 could function to notify the user that a message has been received for the, e.g., that the computing system 106 has received a message that is waiting to be delivered to the user. The message indicator 332 may present various different colors and/or blinking patterns to indicate various different message states. For instance, the message indicator could present a fast blinking green light to indicate that a message is waiting for the user.

To facilitate portable use, the device 302 further includes a rechargeable battery 334 to power various components of the device 302. As shown in FIGS. 3B and 3G, the battery 334 could be configured to fit within a battery receptacle at the back of the device 302 in order to establish electrical communication with and supply power to various device components. Further, the battery 334 could be removable by a user to facilitate recharging or replacing the battery. Alternatively, the battery 334 could be permanently housed within the device 302, possibly not removable by the user, and the device 302 could include a wired, inductive, or other mechanism to recharge the battery 334. The battery could be of various types, such as nickel metal hydride (NiMH), nickel cadmium (NiCd), Lithium Ion (Li-Ion), or lithium polymer (Li-Poly), among other possibilities. Further, the device 302 could alternatively use more than one battery and/or another power source.

Because the example device 302 may be largely voice controlled, the device 302 might not include any display screen. Alternatively, the device may include one or more display screens.

In use, to enable the device 302 to receive and process voice commands spoken by the user and to receive other voice audio spoken by the user, it may be best to situate the device 302 about 6 inches below the chin of the user, as shown in FIG. 3H. Further, with the linear microphone array 312 oriented as shown the figures, it may be best to orient the device 302 itself vertically when worn by the user (i.e., with the top of the device 302 facing straight up) so that the linear microphone array of the device 302 will also be oriented vertically. This vertical orientation of the microphone array could help facilitate the device's evaluation of separate microphone audio channels as a basis to determine whether received voice audio is spoken by the user wearing the device or rather by another user. To so orient the device, the clip assembly 306 could be configured with one or more pivot points that enable the device to rotate at its juncture with the clip assembly and hang downward in the desired vertical orientation if possible. In an alternative implementation, a user may carry the user device 302 in a pocket or holster, and the user may then remove the device 302 and bring it into the optimal position to support providing voice commands and other voice audio.

As shown in the exploded view of FIG. 3G, the example user device 302 contains a printed circuit board (PCB) 336. This PCB is configured with numerous components to facilitate operation of the device 302.

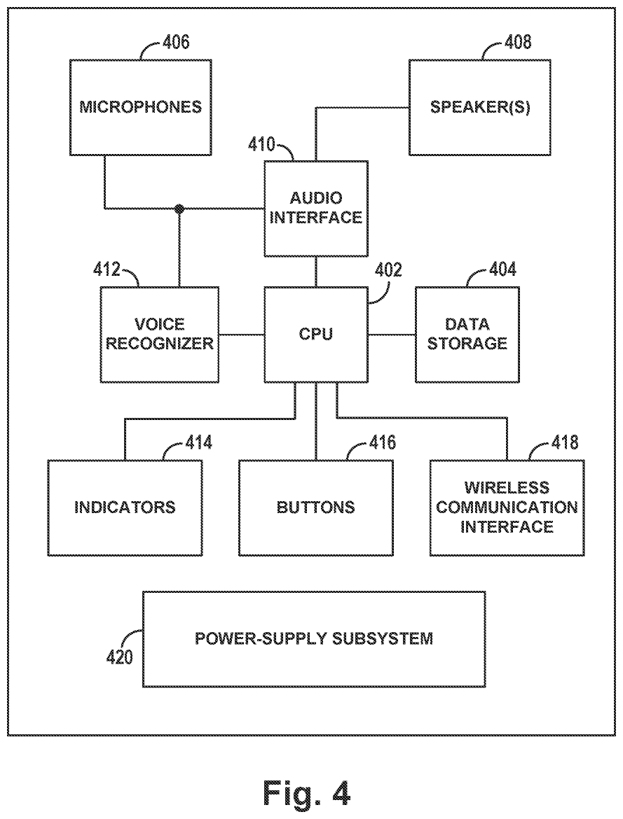

Without limitation, FIG. 4 is next a simplified block diagram illustrating hardware components of the device 302 in an example implementation. As shown in FIG. 4, the device includes a central processing unit (CPU) 402, non-transitory data storage 404, microphones 406, speaker(s) 408, an audio interface 410, a voice recognizer 412, indicators 414, buttons 416, a wireless communication interface 418, and a power-supply subsystem 420. In the example implementation, many of these components could be mounted on the PCB 336.

The CPU 402 functions as a host processor of the device 302, configured generally to control operation of the device 302. CPU 402 could be a Linux processor with an ARM core, among other possibilities and could be mounted on the PCB 336 in electrical, optical, or other communication with various device components as shown, through various pins of the CPU 402.

The CPU 402 could have at least a full-power state and a low-power sleep state and could selectively operate in either of these states. In the full-power state, the CPU 402 could be fully operational, with its CPU clock and system clock running and the CPU executing various applications and performing various computations, consuming a level of battery energy to perform its operations. Whereas, in the sleep state, the CPU clock and various other CPU operations may be halted, so the CPU 402 could consume far less battery energy. Power state of the CPU 402 could operate in accordance with a state machine, which could involve transitioning the CPU 402 from the full-power state to the sleep state in response to various triggers (e.g., after a period of inactivity, or upon learning that the device 302 has left coverage of the system 100) and transitioning the CPU 402 from the sleep state to the full-power state in response to various triggers (e.g., periodically to send heartbeat messages or to scan for WiFi coverage, or upon receipt of an interrupt signal such as when the device 302 detects wake-word utterance), among other possibilities.

The non-transitory data storage 404, which could likewise be mounted on the PCB 336, could comprise one or more volatile and/or non-volatile storage components such as ROM, RAM, EEPROM, flash memory, or optical storage, among other possibilities. For instance, the data storage 404 could include DDR3L memory and/or flash memory. While the data storage 404 is shown separate from the CPU 402, the data storage could alternatively be integrated in whole or in part with the CPU 402. The non-transitory data storage 404 could hold program instructions (e.g., compiled or non-compiled program logic and/or machine code) executable by the CPU 402 to carry out or cause the device 302 to carry out various device processing operations discussed herein. Further, the non-transitory data storage 404 could hold reference data for access by the CPU 402 to facilitate carrying out some of those operations.

The microphones 406, which could also be mounted on the PCB 336, could define the linear microphone array 312 noted above. As indicated above, the microphones 406 could be digital microphones configured to receive acoustic input defining an audio waveform and provide digital output in the form of a sequence of digital samples of the received audio waveform, in a pulse density modulation (PDM) or pulse code modulation (PCM) format for instance, for processing by the CPU 402 and/or the voice recognizer 412. Like the CPU 402, the microphones 406 could have a full-power state and a low-power state and, through CPU control, could selectively operate in and transition between these states. When the CPU 402 transitions to its sleep state, the CPU 402 may also cause one or more of the microphones 406 to enter their sleep state but may keep at least two of the microphones in their full-power state to facilitate their receipt of audio that may represent the wake word.

The speaker(s) 408, which could also be mounted on the PCB 336, could comprise a low profile micro speaker outputting acoustic audio. And the audio interface 410, which could also be mounted on the PCB 336, could be a high-performance, low power audio codec, which could perform analog-to-digital and digital-to-analog conversion among other operations. Digital audio output from the CPU 402 could pass to the audio interface 410, the audio interface could convert that audio to an analog audio waveform, and the speaker(s) 408 could output the audio to be heard by a user. The device 302 may also include an amplifier (not shown) to amplify the audio for output. In addition, the example device 302 may also include a port for connecting a headset and/or may support a wireless headset connection, to facilitate private listening.

The voice recognizer 412, which could also be mounted on the PCB 336, could be a dedicated speech-recognition chipset that operates with low power consumption and could be configured to recognize utterance of particular wake words and other key words. The voice recognizer could run deep-learning algorithms to efficiently detect utterance of a defined wake word, such as “OK Vocera” for instance and could respond to detecting utterance the wake word by signaling to the CPU 402 to trigger further processing.

The indicators 414, which could likewise be mounted on the PCB 336, could comprise the LED indicators noted above, such as the status indicator 326, the connectivity indicator 328, the alert indicator 330, and the message indicator 332. And the buttons 416, which could have communication interfaces with the CPU 402, could comprise the buttons noted above, such as the activation button 318, the DND/hold button 320, the panic button 322, and the volume-control buttons 324.

The wireless communication interface 418, which may also be mounted on the PCB 336, could comprise one or more wireless interfaces configured to enable short-range communication with one or more networks according to one or more wireless local area network (WWAN) protocols such as IEEE 802.11, BLUETOOTH, or ZIGBEE protocols for instance. Further, the wireless communication interface 418 may also include one or more interfaces to enable long-range (e.g., cellular) communication according to one or more wireless wide area network (WWAN) protocols such as LTE or 5G NR for instance. The wireless communication interface 418 could comprise one or more transceivers with transmit and receive chains, as well as one or more antennas to facilitate air-interface communication with access points, base stations, or the like. In some implementations, the antenna(s) of could be integrated with the device housing 304, clip assembly 306, or other component. Alternatively, the antenna(s) could reside completely within the device 302.

Like the CPU 402 and one or more other components of the device 302, the wireless communication interface 418 could have a full-power state and a low-power sleep state and could selectively operate in either of these or other states, under control of the CPU 402 for instance.

Upon transitioning to full-power state, the wireless communication interface 418 (e.g., WiFi module) could scan for coverage of an access point 104 having a predefined service set identifier (SSID), and upon finding such coverage with sufficient signal strength, the wireless communication interface 418 could engage in signaling with the access point 104, to establish a connection between the wireless communication interface 418 and the access point 104, and thus between the device 302 and the access point 104. Upon establishing this connection, the wireless communication interface 418 could then signal to the CPU 402 to inform the CPU 402 that the device is now connected, and the CPU 402 could then take further action, such as to engage in communication over that connection and network 108 with central computing system 106 for instance.

While so connected with an access point 104, the wireless communication interface 418 could further regularly monitor its coverage strength. This monitoring could facilitate triggering handoff of the wireless communication interface 418 between access points as the device 302 moves from one access point's coverage to another access point's coverage. Further, this monitoring could enable the wireless communication interface 418 to detect when it loses wireless coverage (e.g., when a user takes the device 302 out of range of the communication system 100). Upon losing wireless coverage, the wireless communication interface 418 could then transition to the sleep state and could wake up periodically, possibly under CPU control, to newly scan for wireless coverage. Further, while within wireless coverage, the wireless communication interface 418 may from time to time transition from its full-power state to its sleep state. And when in the sleep state while within wireless coverage, the wireless communication interface may apply a listen-interval, waking up periodically (e.g., on the order of every 500 to 700 milliseconds) to check for any unicast messages being wirelessly transmitted to the device 302 and may then transition back to the sleep state absent receipt of such a message.

The power-supply subsystem 420 could then include the battery 334 noted above, configured to supply power to the CPU 402 and other components of the device 302. Further, the power-supply subsystem 420 could include a battery-level gauge (e.g., a voltmeter or coulomb counter), possibly integrated with the battery 334, configured to monitor, report, and manage battery charge level, which could support lighting of a battery-level indicator when appropriate.

To facilitate use of the example user device 302 in practice, a healthcare organization (e.g., hospital) or other organization could equip its facilities with a communication system 100 like that shown in FIG. 1 and could equip each of its workers (e.g., professionals, support staff, and others) with a respective instance of the user device 302. Further, an administrator of the organization could register each such user and user device 302 with the system, through a web-based interface with computing system 106 for instance.

An administrator or user could power on the user device 302 by simply inserting the battery 334 into the device 302, without a need to press a power button, as the device 302 may operate in an always-on state from the user's perspective even though components of the device 302 may transition operate in a sleep state from time to time. So powering on the device 302 could in turn trigger the device scanning for and acquiring wireless connectivity if possible, and engaging in other device operations.

When a user receives an instance of the device 302, perhaps at the time of initial battery insertion, the device 302 may prompt the user to identify himself or herself verbally. Further, the user may need to speak a password provided by the administrator, or the computing system 106 may evaluate a voice signature of the user to confirm that the user is an authorized user. Once the user has identified himself or herself, and upon possible authentication, the computing system 106 may then establish a record associating the user with the instance of the user device 302, so that the computing system 106 could then interact with the user by interacting with that instance of the device 302 (e.g., to facilitate routing calls, messages, and alerts to the user). Once the user is assigned to a given device 302, the device 302 may also output a verbal welcome greeting personalized to the user (e.g., “Hello, John”).

In an example implementation, a particular user device 302 may be assigned to at most one user at a time, and each user may be assigned to just one device 302 at a time. Though a given user device 302 may be reassigned to a different user at another time.

After a user device 302 is assigned to a user, the device 302 may enter the low-power sleep state. In that state, as noted above, the user could utter the predefined wake word to wake up the device, in response to which the device could then transition to a full-power state in order to engage in various device operations.

When the device 302 is operating in full-power state, as the user then utters voice commands or provides other voice audio, the device could transmit that audio through network 108 to the computing system 106 for analysis and processing and/or the device itself may analyze and process some such voice audio. Likewise, the device could receive voice audio and other audio from the computing system 106 and could output that audio audibly for hearing by the user. Further, the device could engage in various other signaling with the computing system 106.

For instance, if the user wishes to call another user named “Bob Smith”, the user may initiate that communication by speaking the voice command “Call Bob Smith”. As the device 302 receives this voice audio, the device 302 may then pass the audio in digital form to the central computing system 106, and a speech recognition engine at the computing system 106 may interpret the command, learning that the user wishes to call user Bob Smith. And in response, the computing system 106 may then engage in signaling with Bob Smith's user device 302 and may bridge the user with Bob Smith so that they can engage in the call. In one implementation, voice call audio could then flow between the user and Bob Smith through the central computing system 106. In an alternative implementation, the central computing system 106 could operate as a third party call controller, to set up the voice call more directly between the two parties.

As noted above, the present disclosure provides various technical mechanisms to help address the technical problems discussed above. Particularly, disclosed herein is a clip assembly that can be clipped to clothes of the wearer and facilitate hanging the user device vertically such that its microphone can correctly receive voice commands from the wearer, and the wearer could also see the indicator lights on the top of the device. Further, disclosed herein is a battery having a structure that ensures both (i) that the battery fits into a battery receptacle of the user device in only one intended orientation, and (ii) that the battery fits into a charging-bay battery receptacle in only one intended orientation.

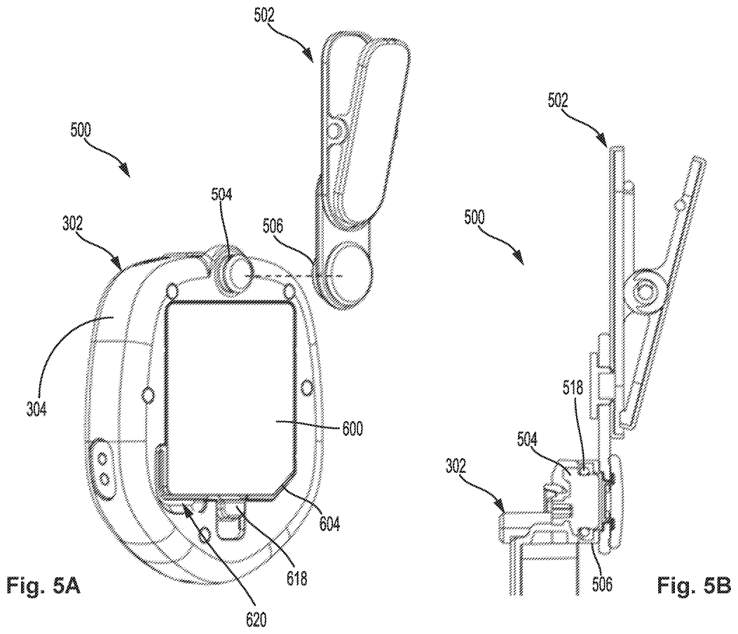

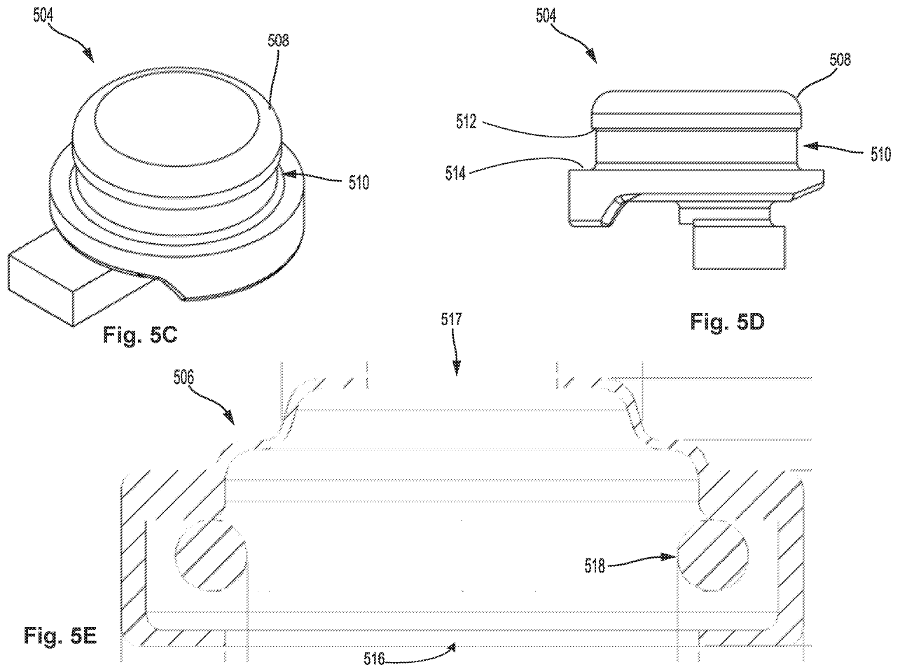

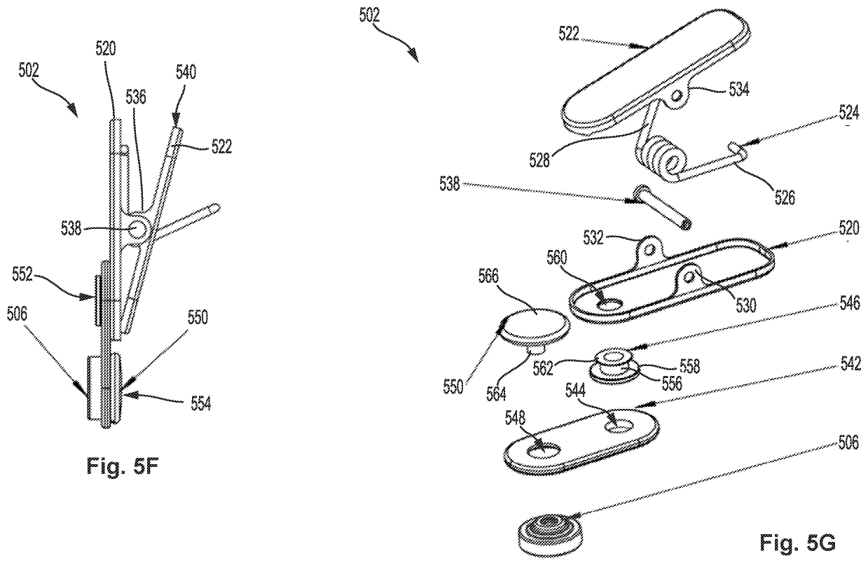

FIG. 5A illustrates an exploded perspective view of an assembly 500 including the user device 302 and a clip assembly 502 (e.g., the clip assembly 306), and FIG. 5B illustrates a partial cross-sectional side view of the assembly 500, in accordance with an example implementation. The clip assembly 502 is configured to facilitate attaching the user device 302 to clothes (e.g., a collar) of a healthcare professional. As such, the user device 302 can be referred to as a wearable device.

The assembly 500 includes a snap insert 504 that is coupled to the user device 302. The clip assembly 502 has a snap button 506 corresponding to the snap insert 504. As described in more details below, the snap insert 504 and the snap button 506 form a snap arrangement to couple the clip assembly 502 to the user device 302.

In an example, the snap insert 504 is made from a metallic material (e.g., stainless steel). In this example, at least a portion of the device housing 304 (e.g., the back cover 310) of the user device 302 is made of a plastic material that is injection-molded around the snap insert 504. This way, the snap insert 504 is an integral part of the device housing 304 of the user device 302.

FIG. 5C illustrates a perspective view of the snap insert 504, and FIG. 5D illustrates a side view of the snap insert 504, in accordance with an example implementation. As shown, the snap insert 504 is generally cylindrical in shape and has a curved or filleted rim 508. The filleted rim 508 facilitates insertion of the snap insert 504 into the snap button 506.

The snap insert 504 further includes an annular groove 510 formed as a recess or depression in the exterior surface of the snap insert 504. The annular groove 510 is bounded by a first annular surface 512 and a second annular surface 514. Notably, the snap insert 504 does not have a large radius fillet or curve between the annular groove 510 and the first annular surface 512. Rather, it might have a small, “natural” fillet or relief, but otherwise the transition from the annular groove 510 to the first annular surface 512 comprises substantially a step with minimal curvature. With this configuration, as described below, the force required to detach the snap button 506 from the snap insert 504 or vice versa is increased relative to a configuration where the transition is curved or filleted.

FIG. 5E illustrates a cross-sectional view of the snap button 506, in accordance with an example implementation. In an example, the snap button 506 is made of a metallic material. For instance, the snap button 506 can be made of a copper-silver alloy.

The snap button 506 has a hole 516 through which the filleted rim 508 of the snap insert 504 is inserted and guided. The snap button 506 has another hole 517 opposite the hole 516, where the hole 517 facilitates coupling the snap button 506 to the clip assembly 502 as described below.

The snap button 506 further includes a flexible ring 518 mounted therein. As the snap insert 504 is inserted and pushed inside the snap button 506, the filleted rim 508 can push the flexible ring 518 outward (i.e., expand the flexible ring). As the filleted rim 508 moves past the flexible ring 518 and the annular groove 510 becomes aligned with the flexible ring 518, the flexible ring 518 then contracts as it is positioned within the annular groove 510. FIG. 5B illustrates the flexible ring 518 in position within the annular groove 510.

The flexible ring 518 interacts with the first annular surface 512 and the second annular surface 514 to retain the snap insert 504 within the snap button 506 and couple the clip assembly 502 to the user device 302. As mentioned above, the first annular surface 512 that bounds the annular groove 510, in which the flexible ring 518 is disposed, does not have a large radius fillet or curve. Rather, it might have a sharp step or minimal fillet to preclude the flexible ring 518 from rolling off readily upon the application of force. This way, the retention force of the snap insert 504 within the snap button 506 is increased.

FIG. 5F illustrates a side view of the clip assembly 502, and FIG. 5G illustrates an exploded perspective view of the clip assembly 502, in accordance with an example implementation. The clip assembly 502 includes a base jaw 520 and a pivotable jaw 522 that are pivotably-coupled to each other.

The clip assembly 502 further includes a torsional spring 524. The torsional spring 524 has a flat leg 526 configured to be aligned with an interior surface of the base jaw 520, and an angled leg 528 coupled to the pivotable jaw 522.

Further, the base jaw 520 includes mounting tab 530 and mounting tab 532. The pivotable jaw 522 also has mounting tab 534 and mounting tab 536 that correspond to the mounting tabs 530, 532 of the base jaw 520. The mounting tabs 530, 532, 534, 536 each has a respective hole formed therethrough.

When the pivotable jaw 522 is mounted to the base jaw 520, holes of the mounting tabs 530, 532 are aligned with respective holes of the mounting tabs 534, 536. Further, the inner space formed within the coils of the torsional spring 524 is also aligned with the holes of the tabs 530, 532, 534, 536.

The clip assembly 502 has a spring pin 538 that is mounted through the holes of the tabs 530, 532, 534, 536 and through the inner space within the coils of the torsional spring 524, thereby coupling the pivotable jaw 522 to the base jaw 520. The spring pin 538 operates as a pivot pin about which the pivotable jaw 522 is allowed to rotate relative to the base jaw 520.

The torsional spring 524 biases the pivotable jaw 522 in the closed position shown in FIG. 5F. When an end 540 of the pivotable jaw 522 is pressed such that the pivotable jaw 522 rotates counter-clockwise in FIG. 5F, the pivotable jaw 522 rotates about the spring pin 538 to an open position to allow attaching the clip assembly 502 to the clothes of the wearer and detaching the clip assembly 502 from the clothes of the wearer. When released, the torsional spring 524 rotates the pivotable jaw 522 back to the closed position in shown FIG. 5F.

The clip assembly 502 further includes a strap 542. The strap 542 is made of a flexible material suitable for medical applications. As an example for illustration, the strap 542 can be made of Thermoplastic Polyurethane (TPU) or silicon.

The strap 542 allows the jaws 520, 522 to move around (e.g., flex backward or forward) relative to the user device 302 without detaching the clip assembly 502 from the user device 302. Further, the strap 542 operates as a connecting member between the jaws 520, 522 of the clip assembly 502 and the user device 302, and is configured to allow both the jaws 520, 522 and the user device 302 to rotate relative to the strap 542.

Particularly, the strap 542 has a first hole 544 through which a rivet 546 is mounted to pivotably couple the strap 542 to the base jaw 520, and has a second hole 548 through which a snap button cap 550 is mounted to pivotably couple the strap 542 to the snap button 506, which is used to couple the clip assembly 502 to the user device 302. This way, (i) a first pivot 552 is formed between the base jaw 520 and the strap 542 such that the strap 542 is pivotably-coupled to the base jaw 520, and (ii) a second pivot 554 is formed between the strap 542 and the snap button 506 to which the user device 302 is snapped, such that the snap button 506 (and the user device 302) is pivotably-coupled to the strap 542.

With this configuration, free rotation points are formed at the first pivot 552 and the second pivot 554, respectively, enabling the center of gravity of the user device 302 to keep it hanging vertically regardless of the position of the clip assembly 502. As such, the linear microphone array of the user device 302 can correctly receive speech commands from the wearer and the wearer could also see the indicator lights on the top of the user device 302.

In particular, the rivet 546 has a shaft 556 and a first head 558 that can be referred to as a pre-formed head. The base jaw 520 has a hole 560 that can be aligned with the hole 544 of the strap 542, and the shaft 556 of the rivet 546 can then be inserted through the hole 544 and the hole 560.

A second head 562 of the rivet 546 is formed after insertion of the shaft 556 through the holes 544, 560. Once the second head 562 is formed, the strap 542 is retained between the first head 558 and the second head 562. With this configuration, the shaft 556 of the rivet 546 operates as a pivot pin about which the strap 542 and the base jaw 520 (and the pivotable jaw 522 coupled thereto) can rotate relative to each other.

Similarly, the snap button cap 550 has a pin 564 protruding from a head portion 566 of the snap button cap 550, and the pin 564 is inserted through the hole 548 of the strap 542 and through the hole 517 of the snap button 506 (see FIG. 5E). The snap button cap 550 also operates as a rivet, and thus, upon insertion of the pin 564 into the snap button 506, another head (not shown) can be formed at the end of the pin 564 similar to the second head 562 of the rivet 546. This way, the strap 542 is retained to the snap button cap 550, and the pin 564 of the snap button cap 550 operates as a pivot pin about which the strap 542 and the user device 302 can rotate relative to each other.

The clip assembly 502 is described herein with reference to the user device 302 as an example for illustration. The clip assembly 502 can be used with any other device or structure.

Referring back to FIG. 5A, the user device 302 has a battery receptacle configured to receive a battery 600. The battery 600 is configured as a removable rechargeable battery. The battery 600 has a structure that ensures both (i) that the battery 600 fits into the battery receptacle of the user device 302 in only one intended orientation, and (ii) that the battery 600 fits into a charging-bay battery receptacle in only one intended orientation.

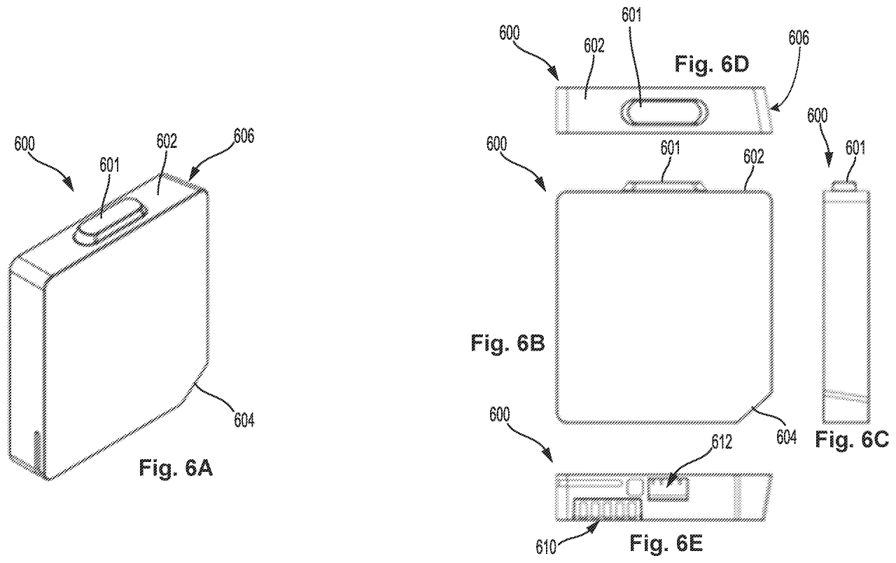

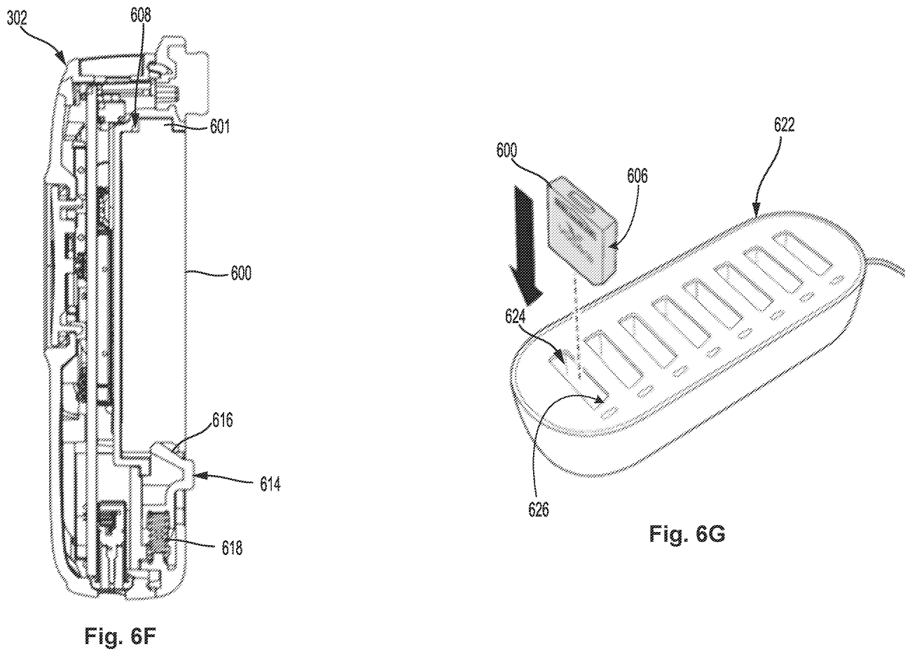

FIG. 6A illustrates a perspective view of the battery 600, FIG. 6B illustrates a front view of the battery 600, FIG. 6C illustrates a side view of the battery 600, FIG. 6D illustrates a top view of the battery 600, and FIG. 6E illustrates a bottom view of the battery 600, in accordance with an example implementation. FIGS. 6A-6E are described together.

The battery 600 is formed as a trapezoidal prism. The battery 600 has an alignment tab 601 formed as a protrusion or a boss on a top surface 602 of the battery 600. Also, the battery 600 has a chamfered corner 604 (e.g., lower right corner in FIGS. 6A-6B). Further, the battery 600 has an inclined or angled side surface 606 (e.g., right side surface). These features of the battery 600 facilitate inserting the battery 600 into the user device 302 in only one correct manner and also facilitate inserting the battery 600 into a charging-bay device in only one correct manner

FIG. 6F illustrates a cross-sectional side view of the user device 302 with the battery 600 disposed therein, in accordance with an example implementation. The user device 302 has a battery receptacle 608 formed as a recess or depression for receiving the battery 600. The battery receptacle 508 has a shape that matches the shape of the battery 600.

Particularly, the battery receptacle 508 has a groove or slot configured to receive the alignment tab 601 of the battery 600 to ensure proper seating and retention of the battery 600 in the user device 302. Further, as shown in FIG. 5A, the battery receptacle 608 also has a chamfered corner that corresponds to the chamfered corner 604.

This way, the battery 600 can be placed into the battery receptacle 608 of the user device 302 in only one orientation. In any other orientation, either the alignment tab 601, the chamfered corner 604, or both will not align with the corresponding features of the battery receptacle 608, and thus the battery 600 cannot be inserted into the user device 302.

As shown in FIG. 6E, the battery 600 has conductive terminals 610 on the bottom surface of the battery 600, opposite the top surface 602, and the user device 302 can have conductive terminals that mate with the conductive terminals 610 of the battery 600 when the battery 600 is inserted into the user device 302. The battery 600 further has a recess or battery slot 612 adjacent the conductive terminals 610 in the bottom surface of the battery 600 that facilitates securing the battery 600 within the user device 302.

To insert the battery 600 into the battery receptacle 608, the alignment tab 601 can be aligned with the corresponding slot in the user device 302, and the chamfered corner 604 is aligned with the corresponding chamfered corner of the user device 302. The battery 600 is then pushed in place.

As shown in FIG. 6F, the user device 302 has a latch 614 having a flap 616. The latch 614 is spring-loaded or biased upward in FIG. 6F via a spring 618. When the battery 600 is inserted into the battery receptacle 608, the battery 600 pushes the latch 614 via the flap 616 downward against the spring 618. When the flap 616 becomes aligned with the battery slot 612 of the battery 600, the spring 618 pushes the latch 614 upward such that the flap 616 is received within or resides in the battery slot 612, and the battery 600 is thus retained and secured to the user device 302.

The user device 302 can have a thumb groove 620 as shown in FIG. 5A. To release the battery 600, a user can press the latch 614 while lifting the battery 600 via a thumb finger placed in the thumb groove 620. The battery 600 can then be placed in a charging bay for recharging.

FIG. 6G illustrates a perspective view of a charging bay 622 and the battery 600 being placed therein for recharging, in accordance with an example implementation. The charging bay 622 has multiple slots available for charging multiple batteries at the same time.

For example, the charging bay 622 can have a charging slot 624. The charging slot 624 has a tilted or angled side surface 626 that corresponds to the angled side surface 606 of the battery 600. With this configuration, the battery 600 has to be inserted in the correct orientation in which the angled side surface 606 of the battery is aligned with the angled side surface 626 of the charging slot 624. Otherwise, in any other orientation, the battery 600 does not fit in the charging slot 624.

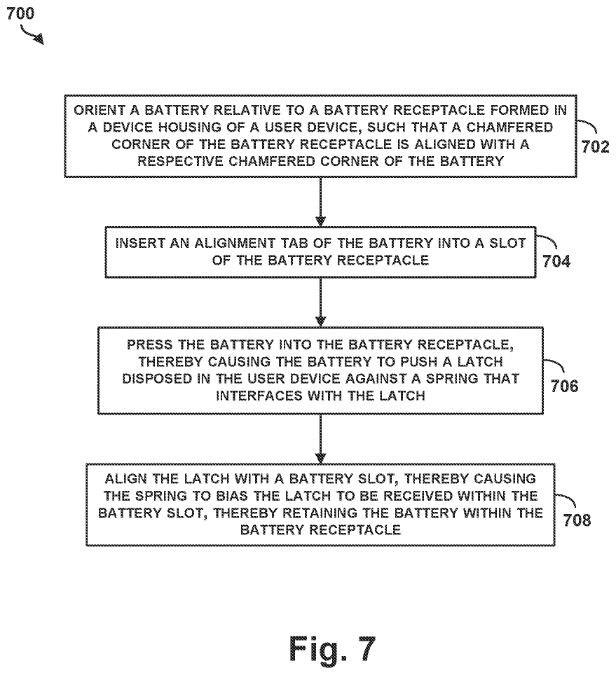

FIG. 7 is a flow chart of a method 700 for coupling the battery 600 to the user device 302, in accordance with an example implementation. The method 700 may include one or more operations, functions, or actions as illustrated by one or more of blocks 702-708. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 702, the method 700 includes orienting the battery 600 relative to the battery receptacle 608 formed in the device housing 304 of the user device 302, such that the chamfered corner of the battery receptacle is aligned with the chamfered corner 604 of the battery 600.

At block 704, the method 700 includes inserting the alignment tab 601 of the battery 600 into a slot of the battery receptacle 608.

At block 706, the method 700 includes pressing the battery 600 into the battery receptacle 608, thereby causing the battery 600 to push the latch 614 disposed in the user device 302 against the spring 618 that interfaces with the latch 614.

At block 708, the method 700 includes aligning the latch 614 with the battery slot 612, thereby causing the spring 618 to bias the latch 614 to be received within the battery slot 612, thereby retaining the battery 600 within the battery receptacle 608.

The method 700 can further include other steps described herein. For example, the method can include inserting a finger into the thumb groove 620, and pulling the battery 600 with the finger to remove the battery 600 from the battery receptacle 608. The method can further include aligning the angled side surface 606 of the battery 600 with the angled side surface 626 of the charging slot 624 of the charging bay 622, then inserting the battery 600 into the charging slot 621 of the charging bay 622.

Embodiments of the present disclosure can thus relate to one of the enumerated example embodiments (EEEs) listed below.

EEE 1 is an assembly comprising: a user device comprising a snap insert, wherein the snap insert comprises an annular groove bounded by a first annular surface and a second annular surface; and a clip assembly comprising: a base jaw, a pivotable jaw that is pivotably-coupled to the base jaw, a strap that is pivotably-coupled to the base jaw at a first end of the strap, and a snap button that is pivotably-coupled to the strap at a second end of the strap, wherein the snap button comprises a hole and a flexible ring mounted therein, such that as the snap insert of the user device is inserted into the snap button through the hole, the flexible ring is positioned within the annular groove and retained between the first annular surface and the second annular surface, such that the user device is pivotably-coupled to the second end of the strap.

EEE 2 is the assembly of EEE 1, further comprising: a torsional spring mounted between the base jaw and the pivotable jaw, wherein the torsional spring biases the pivotable jaw to a closed position.

EEE 3 is the assembly of EEE 2, wherein the base jaw comprises at least one mounting tab having a hole, wherein the pivotable jaw comprises at least one respective mounting tab having a respective hole aligned with the hole of the least one mounting tab of the base jaw, and wherein the assembly further comprises: a spring pin mounted through the hole of the base jaw, the respective hole of the pivotable jaw, and inner space within coils of the torsional spring, and wherein the spring pin is configured as a pivot pin about which the pivotable jaw rotates relative to the base jaw.

EEE 4 is the assembly of any of EEEs 1-3, further comprising: a rivet mounted through the first end of the strap and through the base jaw, such that the strap is retained to the base jaw via the rivet, and wherein the rivet is configured as a pivot pin about which the strap and the base jaw rotate relative to each other.

EEE 5 is the assembly of EEE 4, wherein the rivet comprises: a first head formed prior to inserting the rivet through the first end of the strap; a shaft; and a second head formed after inserting the rivet through the first end of the strap and the base jaw, such that the strap is retained between the first head and the second head and allowed to rotate about the shaft relative to the base jaw.

EEE 6 is the assembly of any of EEEs 1-5, wherein the hole of the snap button is a first hole, wherein the snap button comprises a second hole opposite the first hole, and wherein the assembly further comprises: a snap button cap having a head portion and a pin protruding from the head portion, wherein the pin is inserted through the strap and through the second hole of the snap button, such that the strap is allowed to rotate about the pin relative to the user device.

EEE 7 is the assembly of any of EEEs 1-6, wherein, as the user device is pivotably-coupled to the second end of the strap and the strap is pivotably coupled to the base jaw, the user device is allowed to pivot freely such that the user device assumes a substantially vertical orientation when the clip assembly attaches the user device to clothes of a wearer.

EEE 8 is the assembly of any of EEEs 1-7, wherein a transition from the annular groove to the first annular surface comprises substantially a step to preclude the flexible ring from rolling off.

EEE 9 is the assembly of any of EEEs 1-8, wherein the snap insert comprises a filleted rim that facilitates insertion of the snap insert into the snap button.

EEE 10 is a user device comprising: a device housing; a snap insert coupled to the device housing, wherein the snap insert comprises an annular groove bounded by a first annular surface and a second annular surface; and a clip assembly comprising: a base jaw, a pivotable jaw that is pivotably-coupled to the base jaw, a strap that is pivotably-coupled to the base jaw at a first end of the strap, and a snap button that is pivotably-coupled to the strap at a second end of the strap, wherein the snap button comprises a hole and a flexible ring mounted therein, such that as the snap insert is inserted into the snap button through the hole, the flexible ring is positioned within the annular groove and retained between the first annular surface and the second annular surface, such that the device housing is pivotably-coupled to the second end of the strap.

EEE 11 is the user device of EEE 10, wherein, as the device housing is pivotably-coupled to the second end of the strap and the strap is pivotably coupled to the base jaw, the device housing is allowed to pivot freely such that the device housing assumes a substantially vertical orientation when the clip assembly attaches the device housing to clothes of a wearer.

EEE 12 is the user device of any of EEEs 10-11, wherein the clip assembly further comprises: a torsional spring mounted between the base jaw and the pivotable jaw, wherein the torsional spring biases the pivotable jaw to a closed position.

EEE 13 is the user device of EEE 12, wherein the base jaw comprises at least one mounting tab having a hole, wherein the pivotable jaw comprises at least one respective mounting tab having a respective hole aligned with the hole of the least one mounting tab of the base jaw, and wherein the clip assembly further comprises: a spring pin mounted through the hole of the base jaw, the respective hole of the pivotable jaw, and inner space within coils of the torsional spring, and wherein the spring pin is configured as a pivot pin about which the pivotable jaw rotates relative to the base jaw.

EEE 14 is the user device of any of EEEs 10-13, wherein the clip assembly further comprises: a rivet mounted through the first end of the strap and through the base jaw, such that the strap is retained to the base jaw via the rivet, and wherein the rivet is configured as a pivot pin about which the strap and the base jaw rotate relative to each other.

EEE 15 is the user device of EEE 14, wherein the rivet comprises: a first head formed prior to inserting the rivet through the first end of the strap; a shaft; and a second head formed after inserting the rivet through the first end of the strap and the base jaw, such that the strap is retained between the first head and the second head and allowed to rotate about the shaft relative to the base jaw.

EEE 16 is the user device of any of EEEs 10-15, wherein the hole of the snap button is a first hole, wherein the snap button comprises a second hole opposite the first hole, and wherein the clip assembly further comprises: a snap button cap having a head portion and a pin protruding from the head portion, wherein the pin is inserted through the strap and through the second hole of the snap button, such that the strap is allowed to rotate about the pin relative to the user device.

EEE 17 is the user device of any of EEEs 10-16, wherein a transition from the annular groove to the first annular surface comprises substantially a step to preclude the flexible ring from rolling off.

EEE 18 is the user device of any of EEEs 10-17, wherein the device housing comprises a front cover and a back cover, wherein the snap insert is positioned on the back cover of the device housing, such that the clip assembly is coupled to the back cover of the device housing.

EEE 19 is the user device of EEE 18, wherein the user device comprises a linear microphone array that is accessible through respective holes in the front cover of the device housing, wherein the user device is allowed to pivot freely such that the user device assumes a substantially vertical orientation when the clip assembly attaches the user device to clothes of a wearer, thereby maintaining the linear microphone array in a vertical orientation.

EEE 20 is the user device of any of EEEs 10-19, wherein the snap insert is made of a metallic material, and wherein at least a portion of the device housing is made of a plastic material that is injection-molded around the snap insert, such that the snap insert is an integral part of the device housing.

Exemplary embodiments have been described above. Those skilled in the art will understand, however, that changes and modifications may be made to these embodiments without departing from the true scope and spirit.

1. An assembly comprising:
a user device comprising a device housing, a snap insert, wherein the snap insert comprises an annular groove bounded by a first annular surface and a second annular surface; and
a clip assembly comprising:
a base jaw,
a pivotable jaw that is pivotably-coupled to the base jaw,
a strap that is pivotably-coupled to the base jaw at a first end of the strap, and
a snap button that is pivotably-coupled to the strap at a second end of the strap, wherein the snap button comprises a hole and a flexible ring mounted therein, such that as the snap insert of the user device is inserted into the snap button through the hole, the flexible ring is positioned within the annular groove and retained between the first annular surface and the second annular surface, such that the user device is pivotably-coupled to the second end of the strap,
wherein the user device comprises a linear microphone array that is accessible through respective holes in the device housing, wherein the user device is allowed to pivot freely such that the user device assumes a substantially vertical orientation when the clip assembly attaches the user device to clothes of a wearer, thereby maintaining the linear microphone array in the substantially vertical orientation.

2. The assembly of claim 1, further comprising:
a torsional spring mounted between the base jaw and the pivotable jaw, wherein the torsional spring biases the pivotable jaw to a closed position.

3. The assembly of claim 2, wherein the base jaw comprises at least one mounting tab having a hole, wherein the pivotable jaw comprises at least one respective mounting tab having a respective hole aligned with the hole of the least one mounting tab of the base jaw, and wherein the assembly further comprises:
a spring pin mounted through the hole of the base jaw, the respective hole of the pivotable jaw, and inner space within coils of the torsional spring, and wherein the spring pin is configured as a pivot pin about which the pivotable jaw rotates relative to the base jaw.

4. The assembly of claim 1, further comprising:
a rivet mounted through the first end of the strap and through the base jaw, such that the strap is retained to the base jaw via the rivet, and wherein the rivet is configured as a pivot pin about which the strap and the base jaw rotate relative to each other.

5. The assembly of claim 4, wherein the rivet comprises:
a first head formed prior to inserting the rivet through the first end of the strap;
a shaft; and
a second head formed after inserting the rivet through the first end of the strap and the base jaw, such that the strap is retained between the first head and the second head and allowed to rotate about the shaft relative to the base jaw.

6. The assembly of claim 1, wherein the hole of the snap button is a first hole, wherein the snap button comprises a second hole opposite the first hole, and wherein the assembly further comprises:
a snap button cap having a head portion and a pin protruding from the head portion, wherein the pin is inserted through the strap and through the second hole of the snap button, such that the strap is allowed to rotate about the pin relative to the user device.

7. (canceled)

8. The assembly of claim 1, wherein a transition from the annular groove to the first annular surface comprises substantially a step to preclude the flexible ring from rolling off.

9. The assembly of claim 1, wherein the snap insert comprises a filleted rim that facilitates insertion of the snap insert into the snap button.

10. A user device comprising:
a device housing;
a linear microphone array accessible through respective holes in the device housing;
a snap insert coupled to the device housing, wherein the snap insert comprises an annular groove bounded by a first annular surface and a second annular surface; and
a clip assembly comprising:
a base jaw,
a pivotable jaw that is pivotably-coupled to the base jaw,
a strap that is pivotably-coupled to the base jaw at a first end of the strap, and
a snap button that is pivotably-coupled to the strap at a second end of the strap, wherein the snap button comprises a hole and a flexible ring mounted therein, such that as the snap insert is inserted into the snap button through the hole, the flexible ring is positioned within the annular groove and retained between the first annular surface and the second annular surface, such that the device housing is pivotably-coupled to the second end of the strap,
wherein the user device is allowed to pivot freely such that the user device assumes a substantially vertical orientation when the clip assembly attaches the user device to clothes of a wearer, thereby maintaining the linear microphone array in the substantially vertical orientation.

11. (canceled)

12. The user device of claim 10, wherein the clip assembly further comprises:
a torsional spring mounted between the base jaw and the pivotable jaw, wherein the torsional spring biases the pivotable jaw to a closed position.

13. The user device of claim 12, wherein the base jaw comprises at least one mounting tab having a hole, wherein the pivotable jaw comprises at least one respective mounting tab having a respective hole aligned with the hole of the least one mounting tab of the base jaw, and wherein the clip assembly further comprises:
a spring pin mounted through the hole of the base jaw, the respective hole of the pivotable jaw, and inner space within coils of the torsional spring, and wherein the spring pin is configured as a pivot pin about which the pivotable jaw rotates relative to the base jaw.

14. The user device of claim 10, wherein the clip assembly further comprises:
a rivet mounted through the first end of the strap and through the base jaw, such that the strap is retained to the base jaw via the rivet, and wherein the rivet is configured as a pivot pin about which the strap and the base jaw rotate relative to each other.

15. The user device of claim 14, wherein the rivet comprises:
a first head formed prior to inserting the rivet through the first end of the strap;
a shaft; and
a second head formed after inserting the rivet through the first end of the strap and the base jaw, such that the strap is retained between the first head and the second head and allowed to rotate about the shaft relative to the base jaw.

16. The user device of claim 10, wherein the hole of the snap button is a first hole, wherein the snap button comprises a second hole opposite the first hole, and wherein the clip assembly further comprises:
a snap button cap having a head portion and a pin protruding from the head portion, wherein the pin is inserted through the strap and through the second hole of the snap button, such that the strap is allowed to rotate about the pin relative to the user device.

17. The user device of claim 10, wherein a transition from the annular groove to the first annular surface comprises substantially a step to preclude the flexible ring from rolling off.

18. The user device of claim 10, wherein the device housing comprises a front cover and a back cover, wherein the snap insert is positioned on the back cover of the device housing, such that the clip assembly is coupled to the back cover of the device housing.

19. The user device of claim 18, wherein the respective holes are in the front cover of the device housing.

20. The user device of claim 10, wherein the snap insert is made of a metallic material, and wherein at least a portion of the device housing is made of a plastic material that is injection-molded around the snap insert, such that the snap insert is an integral part of the device housing.
